(19) United States
(12) Patent Application Publication
(10) Pub. No.: US 2023/0031867 A1
(43) Pub. Date: Feb. 2, 2023

(54) FEED DEVICE FOR AUTOMATICALLY FEEDING A MATERIAL WEB IN A STRETCHING UNIT, UNIT AS WELL AS METHOD

(71) Applicant: Brückner Maschinenbau GmbH & Co. KG, Siegsdorf (DE)

(72) Inventors: Michael MAETZE, Neukirchen (DE); Boris PASTERNACK, Rosenheim (DE); Klaus HÖLLMÜLLER, Marquartstein (DE)

(21) Appl. No.: 17/875,113

(22) Filed: Jul. 27, 2022

(30) Foreign Application Priority Data
Jul. 28, 2021 (DE) 10 2021 119 557.8

(51) Int. Cl. B29C 55/14; B29C 55/20

(52) U.S. Cl. CPC B29C 55/143; B29C 55/20; B29C 2793/0063

(57) ABSTRACT

A feed device for automatically feeding a material web from a first stretching unit to a second stretching unit is disclosed having a conveying device configured to transfer at least one strip of the material web that exits the first stretching unit to a transport device of the second stretching unit.

### FIELD OF THE DISCLOSURE

The disclosure relates to a feed device for automatically feeding a material web into a stretching unit, a corresponding unit as well as a method for this.

### BACKGROUND

To produce thin plastics films, stretching units are used that stretch the provided material web to reduce the thickness of the material web.

Usually, the material web is initially fed into the machine direction orienter in order to stretch the material web in the longitudinal direction, i.e. in the drawing direction. Subsequently, the material web that has been stretched in the longitudinal direction is fed to a transverse direction orienter that stretches the material web traversely to the drawing direction and produces a thin material film, for example a plastics film.

In this regard, the transition from the first stretching unit to the second stretching unit is difficult as the feeding of the material web provided by the first stretching unit must be fed into the second stretching unit during operation of the first stretching unit.

The feeding of the material web into the second stretching unit usually occurs manually with high personnel costs. At the same time, a sufficiently large space must be provided between the first stretching unit and the second stretching unit in order to ensure safe handling of the material web. In addition, it may be necessary or at least preferred and thus desirable to store the material web temporarily.

### SUMMARY

There is the need to provide a feed device as well as a unit for automatically feeding a material web from a first stretching unit to a second stretching unit.

Thus, there is provided a feed device for automatically feeding a material web from a first stretching unit to a second stretching unit, wherein the feed device comprises a conveying device that is designed to transfer at least one strip of the material web exiting the first stretching unit to a transport device of the second stretching unit.

It is now possible by means of the feed device to receive the material web from the first stretching unit and reliably feed this material web into the second stretching unit. Thus, personnel costs are reduced and at the same time, the first stretching unit and the second stretching unit can be placed nearer to each other, thereby making more valuable space available in a production building.

The strip is, for example, a strip of the material web with less width in the traverse direction as the overall material web. The strip can be a guide strip.

In an embodiment, the feed device comprises a severing unit for severing the material web from a feeder means for the first stretching unit, thereby ensuring that no amendments are needed to the way the material web is fed into the first stretching unit.

To be able to guide the material web between both stretching units securely, the feed device can comprise at least a transport roller, in particular a frame comprising two transport rollers, which are designed to guide the material web along a feed path, in particular wherein the frame is designed to guide a feeder means of the first stretching unit at least partially parallel to the feed path.

The feeder means can be, for example or preferably, a feeder chain or a feeder belt.

For example, the feed device comprises a first cutting unit that is designed to divide the material web in the drawing direction into a guide strip and a main strip, or the feed device comprises two first cutting units that are designed to divide the material web in the drawing direction into two guide strips and a main strip which is situated between the two guide strips. The conveying device is designed to transfer said one guide strip or said two guide strips to the transport device of the second stretching unit. In this way, the entire material web does not need to be moved at once, thus simplifying operation.

The first cutting unit is moveable in particular in the traverse direction.

So that the guide strip and the main strip can be guided differently through the conveying device, the first cutting unit or the two first cutting units can be partially, in particular completely, upstream of the conveying device.

In an embodiment, the feed device has a material storage for receiving excess material of the material web, in particular wherein the material storage can be a feeder unit comprising at least two rollers or also an ancillary winder. By means of the material storage, it is possible to initially only transfer the guide strip to the second stretching unit.

For example, the first cutting unit and/or the severing unit are upstream of the material storage.

To determine the position of the longitudinal edge of the material web, the feed device can comprise at least one sensor for detecting the position of the longitudinal edge of the material web in the traverse direction.

In an embodiment of the disclosure, the conveying device comprises a pivotable conveyor that is pivotable between a first position and a second position, wherein the pivotable conveyor in the first position provides a first conveying path, in particular towards the material storage, and in a second position provides a second conveying path towards the transport device of the second stretching unit. By means of the pivotable conveyor, it is possible to set automatically in a targeted manner whether the material web is to be conveyed to the second stretching unit or not.

The pivotable conveyor has, for example, a conveyor belt, in particular a suction conveyor belt or a support plate provided with rollers.

The pivot axis can be located on the upstream side of the conveyor.

The conveyor runs, for example, perpendicularly in the first position.

To convey the guide strip and the main strip to different targets independently of each other, the pivotable conveyor comprises in the traverse direction at least two, in particular three sections that are pivotable independently of each other, in particular wherein at least one outer section or, for example, even said both outer sections is or are additionally moveable in the traverse direction.

In one embodiment, the conveying device comprises a static conveyor, in particular a conveyor belt or a support plate provided with rollers that is downstream of the pivotable conveyor and is arranged in the second conveying path towards the transport device of the second stretching unit. By using a static conveyor, adjustments to the feed rails of the second stretching unit are not necessary.

The conveyor belt is, for example, a suction conveyor belt.

The static conveyor can comprise in the traverse direction at least two sections that are allocated in particular to each one of the feed rails.

For example, the conveyor transfers the material web to the transport device of the second stretching unit.

To increase the reliability of the feed device, the conveying device can comprise at least one edge pressing roller that is located on the downstream edge of the pivotable conveyor when the pivotable conveyor is in the second position.

In a further aspect, the feed device comprises a second cutting unit that is provided in the drawing direction in the first conveying path in the area of the pivotable conveyor, in particular in the downstream half of the area of the pivotable conveyor. By means of the second cutting unit, the guide strip can be cut in the traverse direction reliably.

For example, the feed device comprises a third cutting unit that is provided in the drawing direction in the second conveying path in the area of the pivotable conveyor, in particular in the upstream half of the area of the pivotable conveyor, in order to separate the material web in the event of a malfunction.

In an embodiment of the disclosure, the conveying device comprises a receiving path and an industrial robot with a suction head, wherein the industrial robot is designed to receive at least one section of the material web from the receiving path and to transfer this material web to the transport device of the second stretching unit and/or a static conveyor of the conveying device. By means of the industrial robot, the guideway can be moved safely and reliably.

For example, the receiving path is a part of the feed path and/or the first conveying path. The receiving path can extend perpendicularly.

The static conveyor can comprise in the traverse direction at least two sections that are allocated in particular to each one of the feed rails.

For example, the conveyor transfers the material web to the transport device of the second stretching unit.

To simplify the feeding of the main strip, a support is provided for the material web, wherein the support is pivotable and/or height-adjustable and a conveying path is provided in a position from the receiving path to the transport device of the second stretching unit and/or the static conveyor.

In an embodiment, the feed device comprises a second cutting unit that is located in the drawing direction in the area of the receiving path, in particular in the downstream half of the area of the receiving path. By means of the second cutting unit, the guide strips can be cut in the traverse direction reliably.

The feed device can comprise a third cutting unit that is provided in the drawing direction in the area of the support, in particular in the upstream half of the area of the support, in order to separate the material web in the event of a malfunction.

In an embodiment of the disclosure, the conveying device comprises a further first cutting unit and a second industrial robot with a suction head, wherein the second industrial robot is designed to receive one further section of the material web from the receiving path and to transfer this section to the transport device of the second stretching unit and/or a static conveyor of the conveying device. In this way, it is possible to process two guide strips automatically. For example, this is advantageous in the case of wide material webs.

In a further embodiment of the disclosure, a conveying device comprises a first conveyor and a second conveyor that is downstream of the first conveyor, in particular wherein the first cutting unit is located between the first and second conveyor and/or the material storage is provided downstream of the second conveyor. This enables a particularly space-saving construction.

The conveyor is, for example, a conveyor belt, in particular a suction conveyor belt, or a support plate provided with rollers.

The first conveyor and/or the second conveyor can be height adjustable.

To be capable of automatically feeding material webs of different widths, the first conveyor and/or the second conveyor can comprise a pivotable support flap in the drawing direction on at least one of its sides, wherein the pivot axis of the support flap extends in the drawing direction and the support flap increases the support area of the respective conveyor in the traverse direction when it is pivoted upwards.

Moreover, the object is solved by a unit for processing a material web comprising a first stretching unit, in particular a machine direction orienter, a second stretching unit, in particular a transverse direction orienter, as well as a feed device as previously described, in particular wherein the feed device is arranged between the first stretching unit and the second stretching unit and is designed to receive the material web at the exit of the first stretching unit and to feed this material web into the second stretching unit,

The features and advantages described for the feed device apply equally to the unit and vice versa.

For example, the first stretching unit has a transport path that adjoins the feed path of the conveying device to guarantee permanent guiding of the material web.

To receive the material web securely, the second stretching unit can comprise a transport device with a pair of feed rails, in particular wherein the feed rails each comprise an upper guide plate that is moveable in the traverse direction and has driven guide rollers.

In particular, each of the feed rails is moveable in the traverse direction separately.

For example, the feed rails each have a transport chain with clip units.

The guide rollers can be oblique to the drawing direction and to the traverse direction.

To ensure that the material web is fed securely into the second stretching unit, the conveying device can be connected to the transport device, in particular wherein the pivotable conveyor in the second position adjoins the feed rails or the static conveyor adjoins the guide rails or the second conveyor is arranged at least partially between the feed rails of the second stretching unit.

The object is also solved by a method for automatically feeding a material web from a first stretching unit, in particular a machine direction orienter, into a second stretching unit, in particular a transverse direction orienter, by means of an automatic feed device. The method comprises the following steps:
receiving the material web from the first stretching unit by means of the feed device,
transferring at least one section of the material web to the second stretching unit by means of the feed device.

The features and advantages discussed for the feed device and/or the unit apply equally to the method and vice versa. In this regard, the individual components of the unit and the feed device are designed to also perform the steps to be executed by them.

In particular, it is not necessary to interrupt the operation of the second stretching unit in order to feed the material web.

So that no changes are needed to the way that the material web is fed into the first stretching unit, the method can comprise the following further steps:
separating the start of the material web from a feeder means for the first stretching unit by means of a severing unit of the feed device.

For example, the method comprises the following further steps:
conveying the material web to a material storage of the feed device,
dividing the material web in the drawing direction into a guide strip and a main strip by means of a first cutting unit of the feed device, or dividing the material web in the drawing direction into two guide strips and a main strip that is situated between the guide strips by means of two first cutting units of the feed device,
severing one guide strip or both guide strips in the traverse direction by a second cutting unit of the feed device,
receiving said one guide strip or said two guide strips by means of a conveying device of the feed device,
transferring said one guide strip or said both guide strips to the second stretching unit by means of the conveying device of the feed device, and
fastening, in particular clipping on an outer edge of said one guide strip or an outer edge of each the two guide strips to a transport device of the second stretching unit.

Due to the use of a guide strip, the entire material web does not need to be moved at once, thus simplifying operation.

Within the scope of this disclosure, the outer edge is the edge of the guide strip facing away from the main strip or the middle of the material web.

To tension the material web during feeding, the material web can be gripped by a feeder unit of the material storage and conveyed into the material storage.

In an embodiment of the disclosure, the pivotable conveyor, in particular the section of the pivotable conveyor on which the or one of the guide strips runs, moves into the second position if the corresponding guide strip has been severed by the second cutting unit. Or the suction head of the industrial robot takes up one of the guide strips and then transfers the guide strip to the second stretching unit if the corresponding guide strip has been severed by the second cutting unit. Or, if the corresponding guide strip has been severed by the second cutting unit, the feed rail that is closest to the guide strip moves in the traverse direction towards the second conveyor until the outer edge of the guide strip engages with the feed rail. In each of these ways, the guide strip can be securely feed into the second stretching unit.

To improve the reliability of the feeding further, the method can comprise the following further steps:
moving the first cutting unit in the traverse direction completely through the main strip so that the guide strip corresponds to the material web, and
fastening, in particular clipping on, the further edge of the material web to the transport device of the second stretching unit; or
moving the two first cutting units in the traverse direction towards each other and then removing the cutting units from the material web.

In an embodiment of the disclosure, the section of the pivotable conveyor on which the main strip runs is moved into the second position before or while the first cutting unit is moved. Or the support is pivoted or adjusted in height so that a conveying path is provided from the receiving path to the transport device of the second stretching unit and/or the static conveyor before or while the first cutting unit is moved. Or, as soon as, before or after the first cutting unit is moved, the other one of the feed rails moves in the traverse direction towards the second conveyor until the further edge of the material web engages with the feed rail.

In another aspect of the disclosure, the method comprises the following further steps:
severing the entire material web by a third cutting unit, and
conveyance of the material web to the material storage of the feed device.

As a result, it is not necessary to stop the first stretching unit if the second stretching unit malfunctions.

### BRIEF DESCRIPTION OF THE DRAWINGS

Additional features and advantages of the disclosure are found in the following description as well as the attached drawings to which reference is made. In the drawings:

FIG. 1 shows schematically in a side view a part of a unit for processing a material web according to a first embodiment of the disclosure comprising a feed device according to a first embodiment of the disclosure,

FIG. 2 shows a pivotable conveyor of the feed device according to FIG. 1 in a perspective view,

FIG. 3 shows the unit from FIG. 1 during a step of the method according to the disclosure,

FIG. 4 shows a view of the material web that is conveyed into a material storage of the feed device during the step according to FIG. 3,

FIGS. 5 and 6 show the unit and the material web according to the FIGS. 3 and 4 during a further step of the method according to the disclosure,

FIGS. 7 and 8 show the unit and the material web according to FIGS. 3 and 4 during a further step of the method according to the disclosure,

FIGS. 9 and 10 show the unit and the material web according to FIGS. 3 and 4 during a further step of the method according to the disclosure,

FIG. 11 shows the unit according to FIG. 4 during a step for interrupting material production,

FIG. 12 shows a second embodiment of the unit according to the disclosure comprising a second embodiment of the feed device according to the disclosure in a sectional view that corresponds to FIG. 3,

FIG. 13 shows the front view of the material web according to FIG. 4,

FIGS. 14 and 15 show the unit and the material web according to FIGS. 12 and 13 during a further step of the method,

FIGS. 16 and 17 show the unit and the material web according to FIGS. 12 and 13 during a further step of the method,

FIGS. 18 and 19 show the unit and the material web according to the FIGS. 12 and 13 during a further step of the method,

FIG. 20 shows the unit according to the second embodiment during a step for interrupting production,

FIG. 21 shows a third embodiment of a unit according to the disclosure comprising a third embodiment of a feed device according to the disclosure partially in side view

FIG. 22 shows a conveyor of the feed device of the unit according to FIG. 21 in a perspective view, and

FIG. 23 shows a perspective partial view of a feed rail of the second stretching unit of the unit according to FIG. 21 as well as the conveyor of the feed device,

FIGS. 24 to 27 show the unit according to FIG. 21 in a front view during different steps during execution of a third embodiment of the method according to the disclosure.

### DETAILED DESCRIPTION

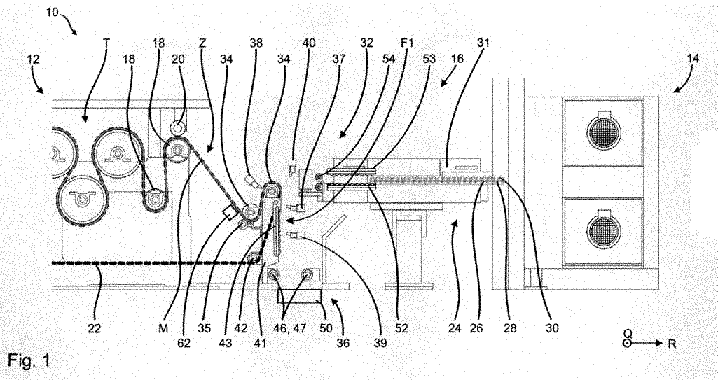

In FIG. 1, a part of a unit 10 for processing a material web M is shown in a schematic side view, said material web M comprising a first stretching unit 12, a second stretching unit 14 as well as a feed device 16.

The material web M is, for example, a plastic film, for example made of polypropylene (PP) or polyethylene terephthalate (PET).

The first stretching unit 12 and the second stretching unit 14 are used to produce an extremely thin material web 2 or a material film from a comparatively thick material web.

Within the scope of this disclosure, the drawing direction R is that direction in which the material web M is conveyed through the unit 10, in the drawings from left to right.

The traverse direction Q is here the horizontal direction traverse to the drawing direction R. The material web M correctly guided into the unit 10 always extends in the traverse direction Q—except for any sagging.

The first stretching unit 12 is, for example, a machine direction orienter (MDO).

The first stretching unit 12 comprises various rollers 18, a least one pressing roller 20 as well as a feeder means 22, for example a feeder chain.

The rollers 18 and the pressing roller 20 form a transport path T that opens into an exit at which the material web M exits the first stretching unit 12.

The feeder means 22, here the feeder chain, runs parallel to the transport path T, for example on gear wheels and/or guide rollers not shown.

The feeder means 22 also extends out of the exit, through sections of the feed device 16 and is finally returned again to the first stretching unit 12.

In the shown embodiment, the second stretching unit 14 is a transverse direction orienter (TDO).

The second stretching unit 14 has a transport device 24 comprising two transport rails 26, on which in each case a multitude of clip units 28 are moved through the second stretching unit 14 by means of a transport chain 30.

Deviating from the shown embodiment, the stretching unit 14 and in particular the transverse direction orienter (TDO) can also be configured in the known manner in the form of a simultaneous stretching unit. This does not have a chain. Instead, the clips are driven and moved by means of linear motors. Stretching units driven by linear motors (for example also in the form of a simultaneous stretching units—what does not necessarily have to be the case, but rather fundamentally also applies to transverse direction orienter) are to be inferred as known, for example, from the prior publications EP 455 632 A1, DE 44 36 676 A1, DE 10 2014 013 901 A1 or, for example, from WO 89/12543 A1 or DE 44 41 020 C1, to which explicit reference is made.

The transport device 24 also comprises two feed rails 31 that each constitute parts of the transport rails 26. The feed rails 31 form an entrance of the second stretching unit 14 that faces the first stretching unit 12.

The material web M can be feed into the transport device 24 of the second stretching unit 14 on the feed rails 31. This occurs, for example, due to the fact that the material web M with its longitudinal edge L1, L2 (FIG. 4) is used in the drawing direction R in the clip units 28 of the feed rails provided on the corresponding side and the clip units 28 are closed. This process is also called “clipping on”. As a result, the clip units grip the material web M and move it into the oven of the first stretching unit 14.

The feed rails 31 have a spacing to each other that is however variable. To this end, the feed rails 31 can be moved individually in the traverse direction Q.

The feed device 16 is located between the exit of the first stretching unit 12 and the entrance of the second stretching unit 14.

The feed device 16 is configured to receive the material web M at the exit of the first stretching unit 12 and to feed the material web M into the feed rails 31 of the second stretching unit 14.

The feed device 16 has a conveying device 32 comprising two transport rollers 34 and a pressing roller 35, a material storage 36, a severing unit 37, a first cutting unit 38, a second cutting unit 39 and a third cutting unit 40.

The transport rollers 34 of the conveying device 32 are located, for example, on a frame 41 of the feed device 16. The frame 41 can be configured separately from the first stretching unit 12 or can be part of a framework or frame of the first stretching unit 12.

The transport rollers 34 are located on the frame 41, for example as what is terms a S-degree of wrapping, wherein the leading transport roller 34 of the two transport rollers 34 is located lower than the trailing transport roller 34.

This can also be reversed so that the trailing transport roller 34 is located lower than the leading transport roller if the material web runs from below the stretching unit 12.

The transport roller 34, in particular the trailing transport roller 34, is, for example, a driven suction roller.

The pressing roller 35 can be located on the leading transport roller 34, in particular below it.

The transport rollers 34 define a feed path Z for the material web M that adjoins the exit of the first stretching unit 12.

The feeder means 22 runs parallel to the feed path Z, thus here the feeder chain of the first stretching unit 12, wherein the frame 41 is configured to guide the feeder means 22 parallel to the feed path Z.

To this end, the frame 41 can comprise gear wheels or guide rollers that are configured accordingly to the transport rollers 34, for example, with the same axis of rotation.

In addition, the frame 41 can have a gear wheel or a guide roller 42 for returning the feeder means 22 to the first stretching unit 12.

Thus, the feeder means 22, here the feeder chain, runs at least partially outside the first stretching unit 12 contrary to the usual superstructures in the prior art.

The conveying device 32 comprises, in addition to the transport rollers 34 shown in the first embodiment in FIG. 1, a pivotable conveyor 43 that is also attached to the frame 41.

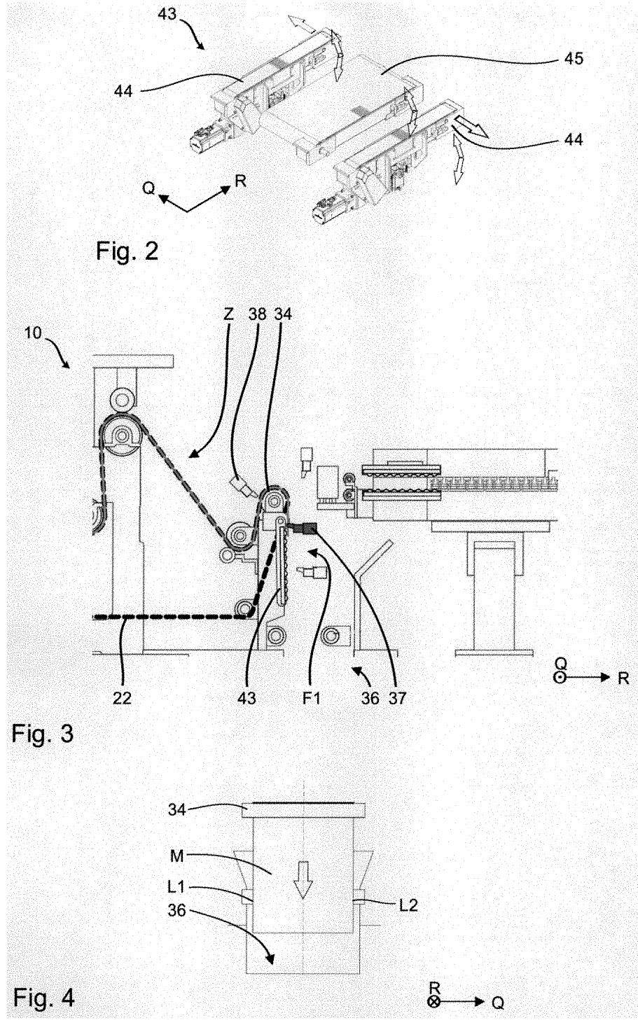

The pivotable conveyor 43 is shown in FIG. 2 optionally.

In the traverse direction Q, the pivotable conveyor 42 has three sections operating independently of each other, namely two edge sections 44 as well as middle section 45 situated between these.

The sections 44, 45 are each attached pivotably with their upstream end on the frame 41 to a pivot axis running in the traverse direction Q.

Moreover, the edge sections 44 are moveable in the traverse direction Q to be capable of securely supporting material web M of varying widths.

Each of the sections 44, 45 comprise a conveyor belt, in particular a suction conveyor belt, in order to move the material web M from the upstream end to the downstream end.

It is also conceivable that the sections 44, 45 each comprise a support plate with driven rollers in order to convey the material web M.

Furthermore, the conveying device 32 comprises a static conveyor in the embodiment shown in FIG. 1.

For example, the static conveyor 52 is a conveyor belt, in particular a suction conveyor belt, or a support plate provided with rollers.

The static conveyor 52 comprises two sections operating independently of each other in the traverse direction Q, wherein each of the sections is allocated to one of the feed rails 31 of the second stretching unit 14.

For example, the sections of the static conveyor 52 are attached to the allocated feed rails 31.

The static conveyor 52 can comprise an upper support plate 53 that is designed to convey strips of the material web M. To this end, the upper support plate 53 can move downwards to convey the respective strip 64, 66 from the upper side.

The static conveyor 52 is thus downstream of the pivotable conveyor 43.

Two edge pressing rollers 54 located only in the edge region of the conveying path F2 can be provided on the downstream end of the pivotable conveyor 43 and/or between the pivotable conveyor 43 and the static conveyor 52.

As can be seen in FIG. 1, the upstream edge of the pivotable conveyor 43 is located downstream of the transport roller 34, in particular directly below the transport roller 34, so that the pivotable conveyor 43 connects directly to the feed path Z.

The pivotable conveyor 43 and each of the sections 44, 45 of the pivotable conveyor 43 can adopt a first position and second position independently of each other.

In FIG. 1, the first position is shown in which the pivotable conveyor 43 and the corresponding sections 44, 45 run perpendicularly downwards.

In this first position, the pivotable conveyor 43 provides the first conveying path F1. The first conveying path F1 runs from the upstream edge of the pivotable conveyor 43, i.e. thus directly adjoining the feed path Z, and extends towards the material storage 36, more specifically to the feeder unit 46.

In the second position of the pivotable conveyor 43 shown in FIG. 7, the downstream edge of the pivotable conveyor 43 extends towards the static conveyor 52. As a result, a second conveying path F2 is provided that extends from the upstream end of the pivotable conveyor 43, thus directly adjoining the feed path Z, across the static conveyor 52 into the transport device 24, thus here the feed rails 31 of the second stretching unit 14.

As the sections 44, 45 of the pivotable conveyor 43 are pivotable independently of each other, the first conveying path F1 can be provided for a strip 66 of the material web M in the traverse direction Q and already the second conveying path F2 for another strip 64 of the material web M along the traverse direction Q if the corresponding section 44 is in the second position.

The material storage 36 is arranged downstream of the pivotable conveyor 43, at least if the pivotable conveyor 43 and the sections 44, 45 are in the first position.

The material storage 36 has a feeder unit 46 comprising two feeder rollers 47. The feeder rollers 47 are arranged opposite to each other, wherein one of the feeder rollers 47 is moveable in order to clamp and move the material web M.

Downstream of the feeder unit 46, the material storage 36 comprises a collection space 50 in which the material of the material web M can be collected. For example, a grinder is located in the collection space 50.

The grinder can grind the material web M into small material chips that can be conveyed back to an extruder in order to recycle the material.

The severing unit 37 is provided in the shown embodiment at the transition between the feed path Z and the first or second conveying path F1, F2. The severing unit 37 is thus located upstream of the material storage 36.

For example, the severing unit 37 is a U-shaped blade or a cutting blade that is positioned in the edge region of the material web M.

The first cutting unit 38 can be designed as a cross cutter and is provided, for example, in the feed path Z, in particular in the region of the trailing transport roller 34.

The first cutting unit 38 comprises a blade 56 that is orientated in the drawing direction R and is moveable in the traverse direction Q.

The first cutting unit 38 is also therefore upstream of the material storage 36, but also to the conveying device 32, in particular to the pivotable conveyor 43.

The second cutting unit 39 can be designed as a cutting knife and is configured to separate the strip 64 of the material web M in the traverse direction Q.

To this end, the second cutting unit 39 can have a rotatable blade that works together with a static blade provided below the material web M in order to cut the material web M like a pair of scissors.

The second cutting unit 39 is located in the area of the first conveying path F1, thus downstream of the trailing transport roller 34. In the shown embodiment, the second cutting unit 39 is provided in the drawing direction R in the area of the pivotable conveyor 43, more specifically in the area of an edge section 44 of the pivotable conveyor 43.

For example, the second cutting unit 39 is located in the downstream half of the area of the pivotable conveyor 43.

The third cutting unit 40 is provided in the area of the second conveying path F2. The third cutting unit 40 can comprise a blade 58 that is moveable in the traverse direction Q along the entire width of the conveying path F2 in order to cut through the material web M in the traverse direction Q completely.

The third cutting unit 40 is located, for example, in the upstream half of the pivotable conveyor 43 if this is in the second position.

In FIGS. 3 to 10, the method according to the disclosure is shown for feeding a material web M from the first stretching unit 12 into the second stretching unit 14 during different steps. Here, the unit 10 is shown in FIGS. 3, 5, 7 and 9, each comprising a feed device 16 in a side view similar to FIG. 1.

In FIGS. 4, 6, 8 and 10, a view of the material web M is shown in the drawing direction R in the area of the material storage 36. The drawing direction R runs here perpendicularly to the drawing plane.

At the start of the method, the material web M is fed through the first stretching unit 12 by means of a feeder means 22, in the shown embodiment a feeder chain. To this end, the material web M is connected to the feeder means 22 by means of a feeder aid, for example a rope.

Here, a hole is made on the front end of the material web M in the drawing direction R, through which the feeder aid, thus the rope, is drawn through. The feeder aid is then connected to the feeder means 22.

Drawn through by the feeder means 22, the material web M then passes through the first stretching unit 12 and also in part the feed device 16 as the feeder means 22 is guided parallel to the feed path Z of the feed device 16.

In this way, the material web M is received by the first stretching unit 12 by means of the feed device 16.

At the start, the pivotable conveyor 43 is completely in its first position, i.e. it is perpendicular.

The feeder aid is separated from the material web M at the transition from the feed path Z to the first conveying path F1. To this end, the severing unit 37 is activated, in the shown embodiment moved towards the material web M.

As a result, the feeder aid, thus the rope, is guided to the U-shaped blade of the severing unit 37 so that the feeder aid is cut. As a result, the material web M is separated from the feeder means 22, thus the feeder chain.

Alternatively, it is conceivable that the severing unit 37 cuts off the material web M along its entire width behind the point at which the feeder aid is installed. As a result, the material web M is detached from the feeder means 22, thus the feeder chain.

The portion of the feeder aid remaining on the feeder means is guided back into the first stretching unit 12 together with the feeder means 22. The feeder means 22 can be stopped or slowed separately from the rollers 18 of the first stretching unit 12 in order to remove the portion of the feeder aid, thus the leftover piece of rope.

At the same time, the material web M runs along the first conveying path F1, i.e. along the pivotable conveyor 43, into the material storage 36.

It can be seen in FIG. 4 that the material web M is undivided along its entire width and is conveyed into the material storage 36 entirely.

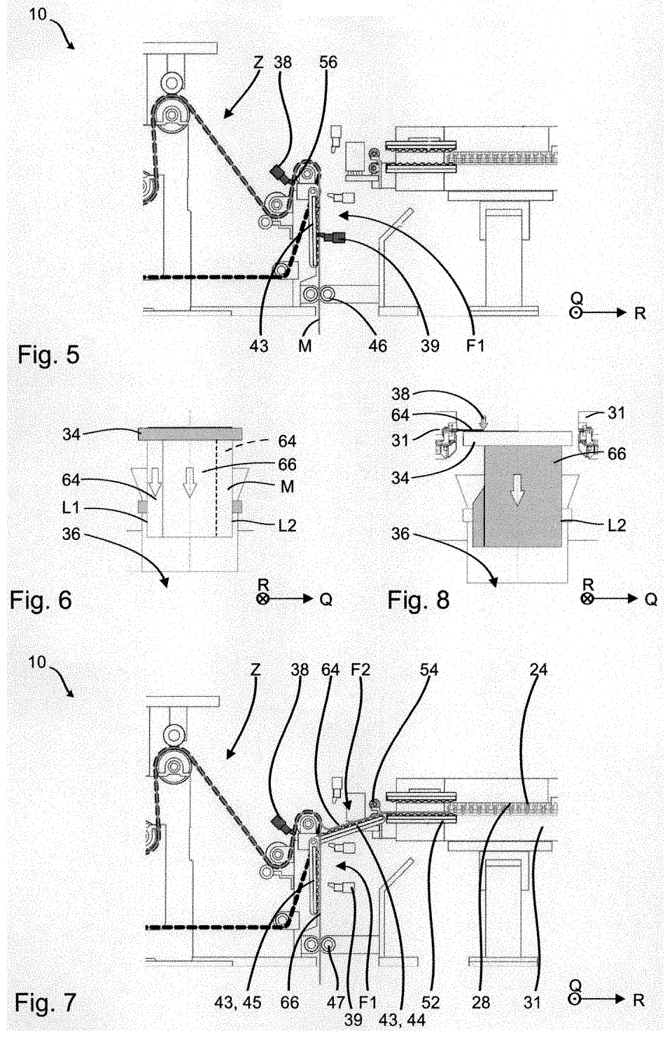

As soon as the material web M that is separated from the feeder means 22 reaches the material storage 36, the feeder unit 46 closes, for example as a result of the feeder rollers 47 moving towards each other and gripping the material web M (cf. FIG. 5).

The desired tensile stress is applied on the material web M in the drawing direction R by means of the feeder rollers 47 of the feeder unit 46 and/or the trailing transport roller 34.

Moreover, the position of one of the edge sections 44 of the pivotable conveyor 43 changes in the traverse direction Q in order to place the pivotable conveyor 43 below the longitudinal edge L1 of the material web M in the drawing direction R.

To this end, the position of the first longitudinal edge L1 of the material web M is measured in the traverse direction Q by means of an edge measuring device 62. The edge measuring device 62 is, for example, a sensor for detecting the position of one of the longitudinal edges L1, L2 of the material web M.

A second edge measuring device 62 is provided on the other side of the material web M in order to measure the position of the second longitudinal edge L2.

The edge measuring device 62 can be part of the feed device 16 and is provided, for example, in the feed path Z. The edge measuring device 62 can also be provided however at another site in the feed path Z or in the first conveying path F1. It is also conceivable that the edge measuring device 62 is an edge measuring device of the first stretching unit 12.

Now, as can be seen in FIG. 5, the first cutting unit 38 is actuated and moved towards the material web M. Here, the blade 56 of the first cutting unit 38 cuts into the material web M and thus creates a cut in the drawing direction R.

As can be seen in FIG. 6, the material web M is thus divided in the drawing direction R into a guide strip 64 and a main strip 66. The guide strip 64 has, for example, a width in the traverse direction of 100 to 300 mm, in particular 200 mm, i.e. that the blade 56 of the first cutting unit 38 cuts into the material web M at this distance from the first longitudinal edge L1.

Both the guide strip 64 and the main strip 66 are initially conveyed into the material storage 36.

As shown in FIG. 7, the guide strip is then cut off in the traverse direction Q with the aid of the second cutting unit 39. For example, the second cutting unit 39 is moved for this purpose in the traverse direction Q from a position outside the location of the material web M to the position of the blade 56 of the first cutting unit 38.

It is also conceivable that the second cutting unit 39 is configured as a severing unit with a predefined width.

As soon as the guide strip 64 has been separated by the first cutting unit 39, the corresponding edge section 44 of the pivotable conveyor 43 located below the guide strip 64 is moved into the second position.

The severed guide strip 64 is then conveyed along the second conveying path F2 to the static conveyor 52.

To facilitate the transition from the pivotable conveyor 43 to the static conveyor 52, the edge pressing roller 54 can be closed to convey the guide strip 64 to the static conveyor 52.

By means of the static conveyor 52, the guide strip 64 is then transferred to the second stretching unit 14, more specifically to that feed rail 31 that is allocated to the first longitudinal edge L1 of the material web M.

Previously, the position of the corresponding feed rail 31 was adapted to the position of the first longitudinal edge L1 and the guide strip 64. For this purpose, the corresponding feed rail 31 was moved in the traverse direction Q.

By means of a static conveyor 52, the outside edge of the guide strip 64 is fed into the feed rail 31 and fastened or clipped on there, i.e. gripped by the clip units 28.

The outside edge of the guide strip is here that edge that is facing away from the main strip 66 or the middle of the material web M.

The guide strip 64 is thus feed into the second stretching unit 14 and is now conveyed further by the transport device 24 of the second stretching unit 14.

The main strip 66, however, continues to run into the material storage 36, as can be seen in FIG. 8. The point at which the guide strip 64 has been severed by the second cutting unit 39 in the traverse direction Q is clearly evident.

To now also convey the main strip 66 of the second stretching unit 14, the second edge section 44 of the pivotable conveyor 43 not supporting the main strip 64 is initially moved below the second longitudinal edge L2 of the material web M.

To this end, the measurement value of the second edge measuring device 62 is used.

Similarly, the second feed rail 31 that does not currently grip the guide strip 64 is moved into the corresponding position of the second longitudinal edge L2 of the material web M in the traverse direction Q.

Now, the first cutting unit 38 moves in the traverse direction in the direction towards the second longitudinal edge L2 of the material web M until the first cutting unit 38 has been moved through the second longitudinal edge L2 and thus completely through the main strip 66.

The width of the guide strip 64 becomes increasingly larger until the width of the guide strip 64 is equal to the width of the material web M, i.e. the guide strip 64 is equal to the material web M.

Just before, at the same time or just after the first cutting unit 38 has passed through the main strip 66 completely, both the middle section 45 and the edge section 44 of the pivotable conveyor 43 are pivoted into the second position.

As a result, the remaining parts of the material web M are now conveyed along the second conveying path F2.

Also in this situation, an edge pressing roller 54 on the second longitudinal edge L2 can support the transfer between the pivotable conveyor 43 and the static conveyor 52.

Subsequently, the second longitudinal edge L2 is fed into the second feed rail 31 allocated to the second longitudinal edge L2 by means of the static conveyor 52. As a result, the second longitudinal edge L2 of the material web M is fastened to the transport device 24, i.e. fed into the clip units 28 and the clips are closed.

To support this feeding, the upper support plate 53 of the static conveyor 52 can move downwards to convey the respective strip 64, 44 from the upper side.

Thus, the second longitudinal edge L2 of the material web M is also fastened securely in the transport device 24 of the second stretching unit 14.

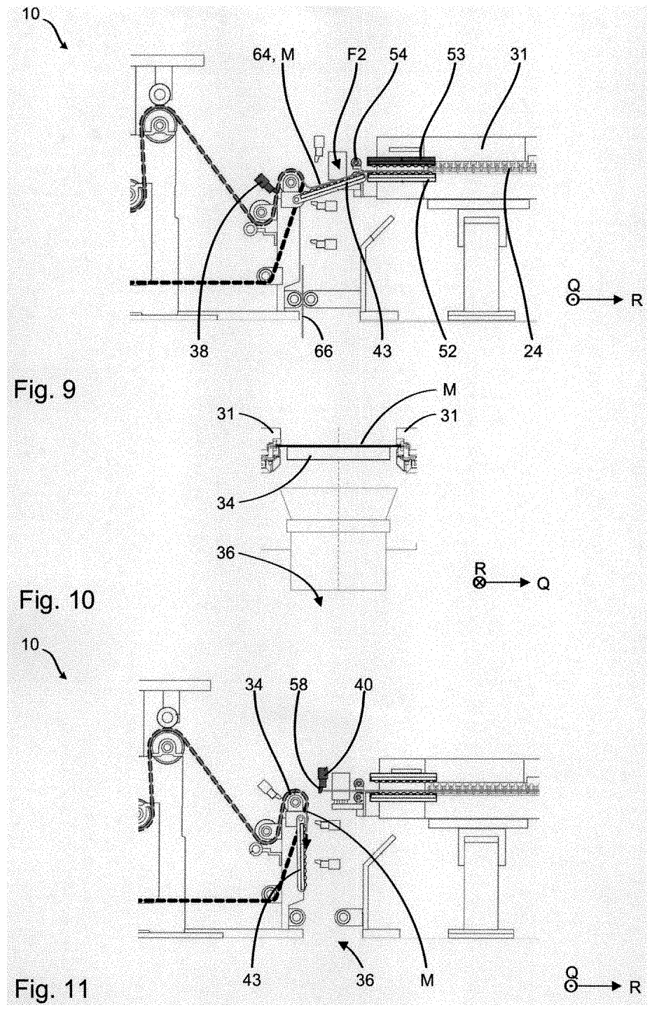

As can be seen in FIG. 9, the entire material web M now runs into the second stretching unit 14 and no strips run any more into the material storage 36.

The material web M is now fed completely into the second stretching unit 14 and the entire unit 10 can now go into production; this means for example an increase in speed and material output. For example, the pivotable conveyor 43 is now pivoted to its first position again.

If the second stretching unit 14 malfunctions, the second stretching unit 14 must be stopped and the feeding of the material web M to the second stretching unit 14 must be halted.

In this case, the entire material web M is completely severed by means of the third cutting unit 40 above the pivotable conveyor 43. For example, the blade 58 of the third cutting unit 40 passes through the material web M completely. The conveyor 43 is in the first position or is moved into the first position if it is still in the second position.

After the third cutting unit 40 has made a cut, the material web M now falls downwards in the direction of the material storage 36 and is received by the material storage 36. In this process, the conveyor 43 can support the film as required and convey it in the direction of the material storage 36.

The feeder unit 46 of the material storage 36 can then be closed in order to convey the material web M into the material storage 36 and to keep the material web M at a predetermined tensile stress.

The first stretching unit 12 can thus continue to be operated although the second stretching unit has malfunctioned.

As soon as the second stretching unit 14 is operational again, the material web M is fed into the second stretching unit 14 as described previously; in doing so, the severing unit 37 is no longer required as the material web M is already conveyed into the material storage 36 in accordance with FIG. 4.

It is thus possible by means of the feed device 16 to receive the material web M from the first stretching unit 12 fully automatically and transfer the material web M to the second stretching unit 14.

Even stoppages of the second stretching unit 14 can be diminished fully automatically and when resuming operations, the material web M is fed into the second stretching unit 14 automatically once more.

Through this automation, the personnel costs involved in feeding the material web M into the second stretching unit 14 can be reduced greatly. At the same time, the first stretching unit 12 and the second stretching unit 14 can be placed closer to each other, thus considerably reducing the overall length of the unit 10.

In the shown first embodiment, it is also conceivable that two guide strips 64 are used.

The method proceeds essentially as the previously described method with one guide strip 64. However, two first cutting units 38 are provided that are located at the same position in the drawing direction R but opposite to each other in the traverse direction Q. Thus, the second cutting unit 39 is hidden by the first cutting unit 38 in the Figures. Correspondingly, there are also two second cutting units 39.

One of the first and one of the second cutting units 38, 39 operate as previously described and the second first cutting unit 38 severs a second guide strip 64 on the second longitudinal edge L2 of the material web M. The width of the second guide strip 64 is equal to, for example, the width of the first guide strip 64. The second guide strip 64 is indicated in FIG. 6 using the dashed line.

A main strip 66 is thus formed again between the first and the second guide strips 64.

To transfer the second guide strip 64, the corresponding edge section 44 of the pivotable conveyor 43 is pivoted into the second position independently of the middle section 45 of the pivotable conveyor 43 in order to transfer the second guide strip 64 to the static conveyor 52. This occurs, for example, simultaneously with the other edge section 44.

This conveys the second guide strip 64 to the second feed rail 31 allocated to the second longitudinal edge L2 so that the outer edge of the second guide strip 64 is fastened in the feed rail 31, in particular is clipped on.

This occurs in particular simultaneously to the severing and clipping on of the first guide strip 64 so that initially only the two guide strips 64 are fed into the second stretching unit 14.

The main strip 66 initially continues to be conveyed for the time being into the material storage 36.

In contrast to the situation with only a first cutting unit 38, the two first cutting units 38 are moved towards each other in the traverse direction Q until they are adjacent to each other. Then, the blades 56 of the first cutting units 38 are withdrawn from the material web M so that the two guide strips 64 and, if applicable, a residual part of the main strip 66 are combined again to be a coherent material web M.

As the outer edge of the guide strips 64 and thus both longitudinal edges L1, L2 of the material web M are already fed into the second stretching unit 14, the entire material web M, i.e. also the part that was previously the main strip 66, is drawn into the second stretching unit 14. To this end, the middle section 45 of the pivotable conveyor 43 is also moved into the second position for support.

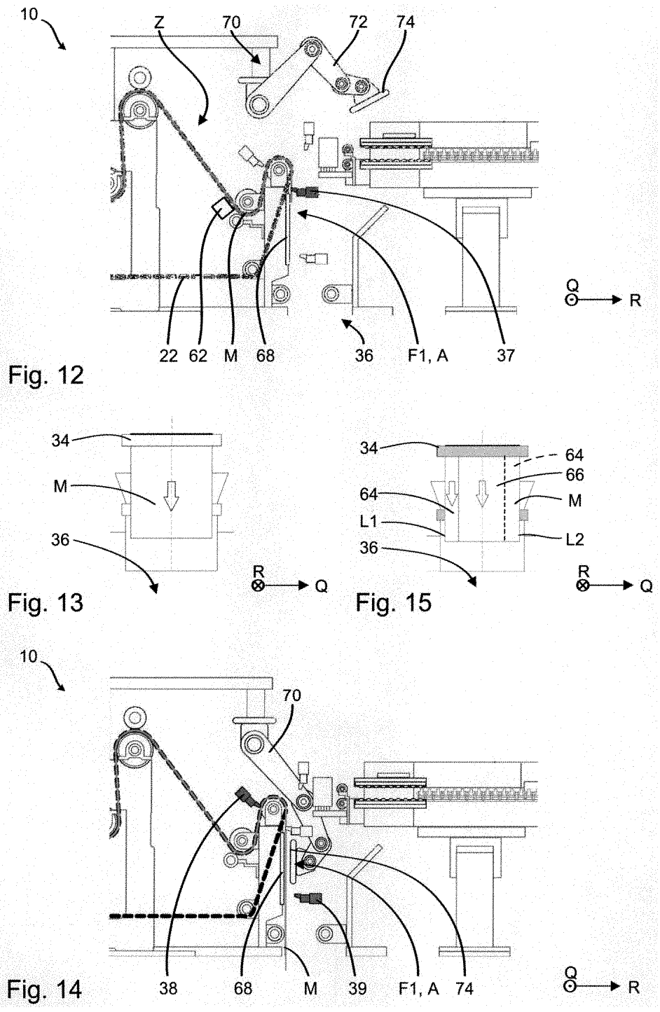

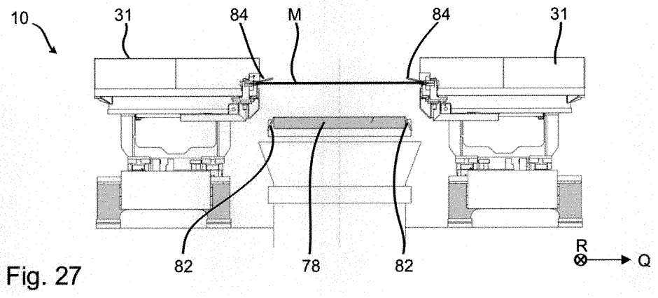

In FIGS. 12 and 27, further embodiments of the disclosure are shown which substantially correspond to the embodiment previously described. Therefore, only the differences are discussed hereinafter and the same parts and parts with the same function are provided with the same reference signs.

In FIG. 12, the unit 10 comprising a feed device 16 according to a second embodiment of the disclosure is illustrated. The representation of FIG. 12 approximately corresponds to that of FIG. 3.

In contrast to the first embodiment, the feed device 16 of the second embodiment does not comprise a pivotable conveyor 43.

Instead of a pivotable conveyor 43, a support 68 can be provided for the material web M.

The support 68 is attached pivotably on the frame 41 in much the same way as the pivotable conveyor 43 and can adopt a first and a second position.

Alternatively or additionally, the support 68 can only be height adjustable.

In the traverse direction, the support 68 can—like the pivotable conveyor 43—have several sections that operate independently of each other. In particular, the support 68 has a middle section.

In a first position, the support 68 rests vertically on the frame 41 so that the material web M can be conveyed by the trailing transport roller 34 into the material storage 36. This corresponds roughly to the first conveying path F1 of the first embodiment.

In the second position, the downstream end of the support 68 is pivoted upwards in the direction of the static conveyor 52.

Thus in the second position, the support 68 provides a conveying path from the trailing transport roller 34 to the static conveyor 52 that corresponds roughly to the second conveying path F2 of the first embodiment.

In the second embodiment, the feed device 16 comprises an industrial robot 70 with a manipulator 72 and a suction head 74 as end effector. The industrial robot 70 is part of the conveying device 32.

The industrial robot 70 is attached, for example, to the frame 41. In the embodiment shown in FIG. 12, the industrial robot 70 is attached to the first stretching unit 12.

The feed device 16 also has a receiving path A. The receiving path A is, for example, a part of the first conveying path F1 if the support 68 is in its first position. The receiving path A extends, for example, perpendicularly.

It is also conceivable that the receiving path A is also a section of the feed path Z.

In the second embodiment, the second cutting unit 37 is located in the area of the receiving path A, in particular in the downstream half of the area of the receiving path A.

The third cutting unit 40 is located in the upstream half of the area of the support 68.

To feed the material web M into the second stretching unit 14, the material web M is first separated from the feeder means 22 as described for the first embodiment by means of a severing unit 37 (cf. FIG. 12).

The entire material web M runs then along the support 68 in the first position perpendicularly downwards into the material storage 36 (cf. FIG. 13).

The feeder unit 46 or the feeder rollers 47 grip the material web M and convey the material web M into the collection space 50. In addition, the tensile stress of the material web M is set.

Subsequently as can be seen in FIG. 14, the industrial robot 70 comprising a suction head 74 moves on the receiving path A, wherein the alignment of the suction head 74 on the longitudinal edge L1 of the material web M occurs using the measurement value of the edge measuring device 62.

At this point, said one or both feed rails 31 can move into the corresponding position in the traverse direction Q.

The first cutting unit 38 is now actuated so that, as described in the first embodiment, the material web M is divided into a guide strip 64 and a main strip 66 (cf. FIG. 15).

The suction head 74 is now moved by the manipulator 72 to the guide strip 64 and takes this, more specifically the suction head 74 draws in the guide strip 64.

In order to receive the guide strip 64, the suction head 74 can press the material web M against the support 68.

During this or afterwards, the suction head 74 can move a bit further in the direction of the feeder unit 46 in order to accommodate the movement of the material web M.

Simultaneously or immediately afterwards, the guide strip is severed downstream of the suction head 74 by means of the second cutting unit 39.

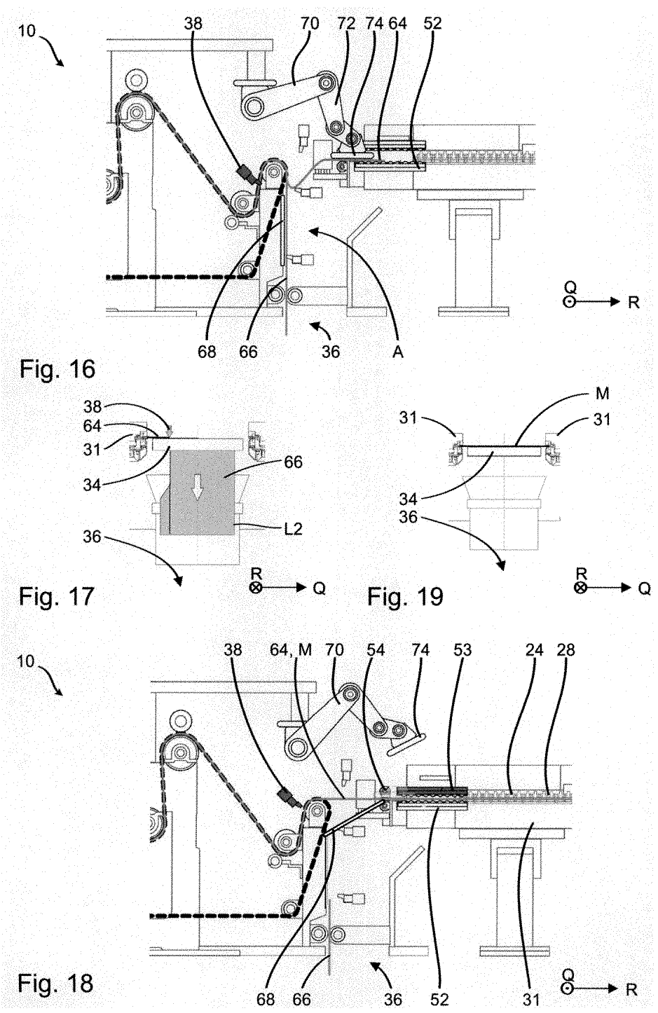

As can be seen in FIG. 16, the industrial robot 70 moves the guide strip towards the second stretching unit 14 and places the guide strip 64 on the static conveyor 52. Then, the suction head 74 releases the guide strip 64 and removes itself from the guide strip 64.

The guide strip 64 is then fed using an outer edge, as described in the first embodiment, through the static conveyor 52 into the feed rails 31 and fastened to the transport device 24.

Alternatively, it is conceivable that the feed device 16 does not comprise a static conveyor 52, but rather the industrial robot 70 feeds the guide strip 64 directly into the feed rails 31 of the second stretching unit 14.

While the guide strip 64 is moved by the industrial robot 70, the main strip 66 continues to be conveyed into the material storage 36, as can be seen in FIG. 17.

Subsequently, if this has not already taken place, the second feed rail 31 of the stretching unit 14 is also moved using the data of the edge measuring device 62 on the other longitudinal edge L2 of the material web M into the position corresponding to the second longitudinal edge L2 in the traverse direction Q.

The first cutting unit 38 now moves, as described in the first embodiment, completely through the main strip 66 in order to increase the guide strip 64.

Moreover, the support 68 pivots into the second position to support the now increasing guide strip 64 and to guide it to the static conveyor 52 or directly into the feed rail 31 (cf. FIG. 18).

As can be seen in FIG. 19, the entire material web now runs into said two guide rails 31 and no longer into the material storage 36.

The material web M is now fed securely so that the second stretching unit 14 can start production.

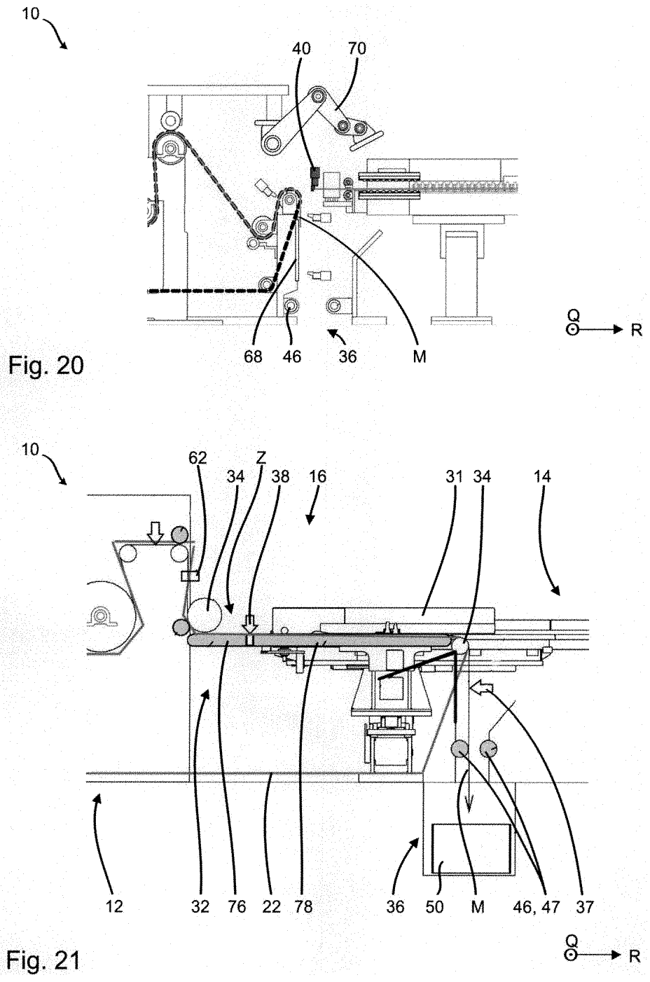

The situation in FIG. 20 is nearly identical to that of FIG. 11, in which the material web M must be completely severed in the event of a stoppage of the second stretching unit 14. To this end, the material web M is separated as already described in the first embodiment by means of the third cutting unit 40 above the feeder unit 46 so that the material web M falls into the feeder unit 46.

It is also possible to use two guide strips 64 according to the principle of the second embodiment. In this case, two first cutting units 38 and two second cutting units 39 are provided that are operated as described for the first embodiment.

Furthermore, a second industrial robot 70 is provided in addition to the first industrial robot 70 on the second longitudinal edge L2 of the material web M, said second industrial robot 70 takes the second guide strip 64 (indicated in FIG. 15 with a dashed line) and moves it to the static conveyor 52 or to the corresponding feed rail 31. This occurs similarly to the movement of the first industrial robot 70 as previously described.

Subsequently, the two first cutting units 38 move—as previously described—towards each other and are then removed from the material web M. In doing so, the support 68 can also be moved in this alternative into the second position in order to support the material web M.

If two industrial robots 70 are used, only the middle section of the support 68 is necessary.

FIGS. 21 to 27 show a third embodiment of the unit 10 according to the disclosure comprising a third embodiment of the feed device 16 according to the disclosure.

In the third embodiment, the conveying device 32 does not have a pivotable conveyor 43 or a pivotable support 68.

The conveying device 32 has a first conveyor 76 and a second conveyor 78 that is downstream of the first conveyor 76.

The first conveyor 76 almost directly adjoins the first stretching unit 12 and provides the feed path Z.

The first and the second conveyor 76, 78 are, for example, conveyor belts, in particular suction conveyor belts, or support plates provided with rollers.

The first cutting unit 38 runs between the first and second conveyors 76, 78 and the material storage 36 is located downstream of the second conveyor 78.

The trailing transport roller 34 is located downstream of the second conveyor 78 as well as the severing unit 37.

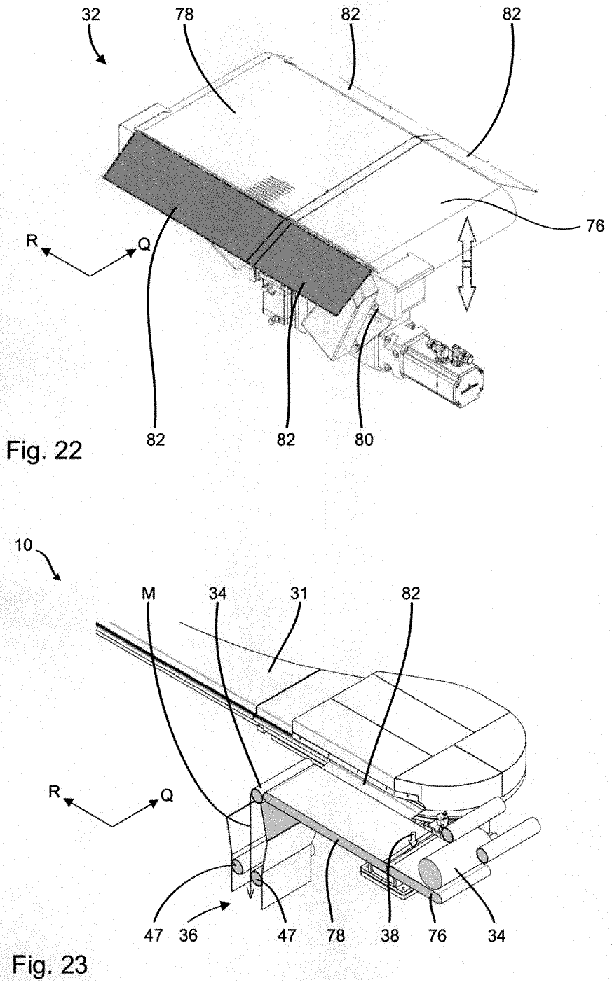

In FIG. 22, the first conveyor 76 and the second conveyor 78 are shown in a perspective view.

It is clearly evident that both conveyors are jointly height adjustable by means of a shared mechanism 80.

It is also evident that the conveyors 76, 78 each comprise a pivotable support flap 82 on each of their longitudinal sides. The pivot axis of the support flap 82 runs in the drawing direction R.

The support flap 82 can be pivoted upwards, thus extending the support area of the conveyor 76, 78 in the traverse direction Q in order to be able to adjust the support area to the width of the material web M.

The conveying device 32, i.e. the first conveyor 76 and the second conveyor 78 are arranged in the traverse direction Q in part between the two feed rails 31 of the second stretching unit 14. In particular, the second conveyor 78 is arranged between the feed rails 31 as is shown in FIG. 23 using the example of one of the feed rails 31.

It is conceivable that the feed rails 31 each comprise one upper guide plate 84 that is provided above a feed gap.

The guide plates 84 are, for example, moveable vertically and comprise driven guide rollers that are aligned obliquely to the drawing direction R and to the traverse direction Q. As a result, the material web M can be actively fed into the clip units 28.

A second cutting unit 39 is not necessary in the feed device 16 of the third embodiment as its function is performed by the first cutting unit 38.

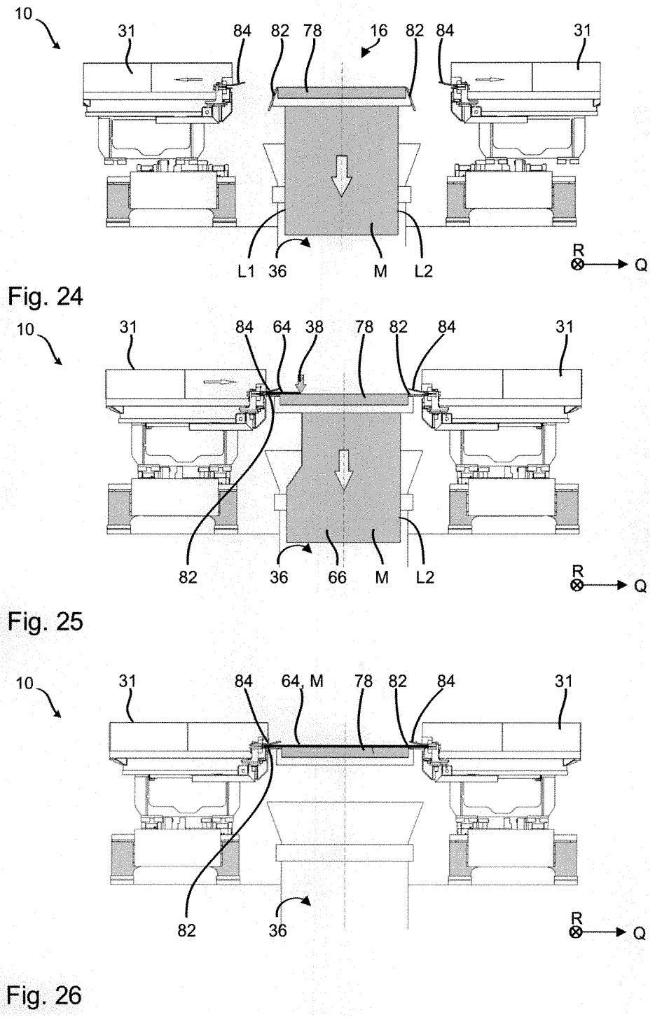

In FIGS. 24 to 27, a sectional view through the unit 10 is shown in the area of the feed rail 31 downstream of the conveying device 32 but towards the drawing direction R to show the method for feeding the material web M into the second stretching unit 12 in different situations.

To feed the material web M into the second stretching unit 14 according to the third embodiment, the conveyors 76, 78 move initially into the operating position at the level of the material web M or at the level of the transport device 24 of the second stretching unit 14.

In the traverse direction Q, the feed rails 31 are moved apart to a maximum width.

The material web M is drawn through the first stretching unit 12 by means of the feeder means 22, similar to as described for the first embodiment, and then drawn through the feed device 16 until the trailing transport roller 34, i.e. on the first and second conveyor 76, 78.

Then, the feeder aid 60 is separated by the severing unit 37 and the material web M is conveyed into the material storage 36. This occurs, for example, already through the conveyors 76, 78.

The feeder unit 46 can then be closed.

Now the desired tensile stress can be applied to the material web M by means of the trailing transport roller 34, the first conveyor 76, the second conveyor 78 and/or in the feeder unit 46 (c.f. FIG. 24).

Moreover, the support flaps 82 of the conveyors 76, 78 extend outwards, i.e. they are pivoted upwards.

In doing so, they are pivoted so far that the support area of the conveyor 76 is increased to the extent that the support area does not fully correspond to the width of the material web M determined by means of edge measuring device 62 but is narrower.

The chosen width of the support area is smaller than the measured width of the material web M so that the material web M protrudes with its longitudinal edges L1, L2 by an excess length on each side in the traverse direction Q.

Said two feed rails 31 are now moved in the direction of the conveyors 76, 78 until the distance between the feed rails 31 and the corresponding support flap 82 is smaller than the excess length of the material web M protruding over the support area in the traverse direction Q.

Thus, the longitudinal edges L1, L2 of the material web M already run in the guide rails 31. By means of the guide plates 84 of the feed rails 31 that extend above the intake of the feed rails in the middle, the material web M is prevented from curling on the longitudinal edges L1, L2.

Now, the first cutting unit 38 is moved from one of the longitudinal edges L1, L2 a bit into the middle of the material web M so that a guide strip 64 is severed.

At the same time, the feed rail 31 continues to move inwards on the side of the material web corresponding to the guide strip 64 until the outer edge of the guide strip 64 engages with the clip units 28 of the feed rail 31 and thus is fastened in the feed rail 31 (FIG. 25).

The first cutting unit 38 moves completely through the material web M, for example in one movement. The second feed rail 31 continues to move inwards to the side opposite the guide strip 64 as soon as the first cutting unit 38 moves completely through the material web M.

The movement of the second feed rail 31 occurs to such an extent until the second longitudinal edge L2 of the material web M is inserted in the feed rail 31 and fastened by means of the clip units 28.

At this point, the entire material web now runs in the second stretching unit 14 and no longer in the material storage 36, as can be seen in FIG. 26.

Now, the conveying device 32 can be moved downwards to prevent unnecessary friction with the material web M.

The material web M is thus completely fed into the second stretching unit 14 so that the unit 10 can now go into production.

In the event of a malfunction of the second stretching unit 14 in the third embodiment, the conveying device 32 is initially moved upwards again until it contacts the material web M in order to convey the material web M into the material storage 36 again. Then, the material web M is completely cut through by means of the first cutting unit 38 and the feed rails 31 move outwards with opened clip units 28 until the material web M no longer runs in the feed rails 31.

Subsequently, the material web M is conveyed through the conveyor 76, 78 into the material storage 36.

Also in the third embodiment, two guide strips 64 can be used. To this end, two first cutting units 38 are also used that sever two guide strips 64 as previously described. The movement of both feed rails 31 for clipping on the outside edges of the guide strips 64 then occurs, for example, simultaneously.

The different features of the different embodiments can be combined with each other.

1. A feed device for automatically feeding a material web from a first stretching unit to a second stretching unit, wherein the feed device comprises a conveying device that is designed to transfer at least one strip of the material web that exits the first stretching unit to a transport device of the second stretching unit.

2. The feed device according to claim 1, further comprising a severing unit for separating the material web from a feeder means for the first stretching unit.

3. The feed device according to claim 1, further comprising a first cutting unit that is designed to divide the material web in the drawing direction into a guide strip and a main strip, or the feed device comprises two first cutting units that are designed to divide the material web in the drawing direction into two guide strips and a main strip which is situated between the two guide strips,
wherein the conveying device is designed to transfer said one guide strip or said two guide strips of the transport device to the second stretching unit.

4. The feed device according to claim 1, wherein the conveying device comprises a pivotable conveyor that is pivotable between a first position and a second position, wherein the pivotable conveyor in the first position provides a first conveying path to the material storage, and in a second position provides a second conveying path to the transport device of the second stretching unit.

5. The feed device according to claim 1, wherein the conveying device comprises at least one edge pressing roller that is located on the downstream edge of the pivotable conveyor when the pivotable conveyor is in the second position.

6. The feed device according to claim 1, further comprising a second cutting unit that is provided in the drawing direction in the first conveying path in the area of the pivotable conveyor, in the downstream half of the area of the pivotable conveyor; and/or that the feed device comprises a third cutting unit that is provided in the drawing direction in the second conveying path in the area of the pivotable conveyor, in the upstream half of the area of the pivotable conveyor.

7. The feed device according to claim 1, wherein the conveying device comprises a receiving path and an industrial robot with a suction head, wherein the industrial robot is designed to receive at least one strip of the material web from the receiving path and to transfer said strip to the transport device of the second stretching unit and/or a static conveyor of the conveying device.

8. The feed device according to claim 7, wherein the feed device comprises a second cutting unit that is located in the drawing direction in the area of receiving path, in the downstream half of the area of the receiving path; and/or that the feed device comprises a third cutting unit that is provided in the drawing direction in the area of the support, in the upstream area of the support .

9. The feed device according to claim 1, wherein the conveying device comprises a further first cutting unit and a second industrial robot with a suction head, wherein the second industrial robot is designed to receive a further strip of the material web from the receiving path and to transfer said strip to the transport device of the second stretching unit and/or a static conveyor of the conveying device.

10. The feed device according to claim 1, wherein a conveying device comprises a first conveyor and a second conveyor that is downstream of the first conveyor, wherein the first cutting unit is located between the first and second conveyor and/or the material storage is provided downstream of the second conveyor.

11. The feed device according to claim 10, wherein the first conveyor and/or the second conveyor comprises a pivotable support flap on at least one of its sides in the drawing direction, wherein the pivot axis of the support flap extends in the drawing direction and the support flap increases the support area of the respective conveyor in the traverse direction when it is pivoted upwards.

12. A unit for processing a material web comprising a first stretching unit, a machine direction orienter, a second stretching unit, a transverse direction orienter, as well as the feed device according to claim 1, wherein the feed device is located between the first stretching unit and the second stretching unit and is designed to receive the material web at the exit of the first stretching unit and to feed said material web into the second stretching unit.

13. The unit according to claim 12, wherein the second stretching unit comprises a transport device with a pair of feed rails, wherein the feed rails each comprise an upper guide plate that is moveable in the traverse direction and has driven guide rollers.

14. The unit according to claim 13, wherein the conveying device adjoins the transport device, wherein the pivotable conveyor in the second position adjoins the feed rails or the static conveyor adjoins the feed rails; or that the second conveyor is located at least partially between the feed rails of the second stretching unit.

15. A method for automatically feeding a material web from a first stretching unit, a machine direction orienter, to a second stretching unit, a transverse direction orienter, by means of an automatic feed device, having the following steps:
receiving the material web from the first stretching unit by means of the feed device,
transferring at least one strip of the material web to the second stretching unit by means of the feed device.

16. The method according to claim 15, having the following further steps:
conveying the material web to a material storage of the feed device,
dividing the material web in the drawing direction into a guide strip and a main strip by means of a first cutting unit of the feed device, or dividing the material web in the drawing direction into two guide strips and a main strip situated between the guide strips by means of two first cutting units of the feed device,
receiving said one guide strip or said two guide strips by means of a conveying device of the feed device,
severing one guide strip or both guide strips in the traverse direction by means of a second cutting unit of the feed device,
transferring said one guide strip or said two guide strips to the second stretching unit by means of the conveying device of the feed device, and
fastening an outer edge of said one guide strip or an outer edge of each said two guide strips to a transport device of the second stretching unit.

17. The method according to claim 16, wherein the material web is gripped by a feeder unit of the material storage and conveyed into the material storage.

18. The method according to claim 16, wherein the pivotable conveyor, the section of the pivotable conveyor on which the or one of the guide strips runs, is moved to the second position if the corresponding guide strip has been severed by the second cutting unit, or
that the suction head of the industrial robot takes one of the guide strips and then transfers the guide strip to the second stretching unit if the corresponding guide strip has been severed by the second cutting unit, or
that if the corresponding guide strip has been severed by the second cutting unit, the feed rail that is closest to the guide strip moves in the traverse direction towards the second conveyor until the outer edge of the guide strip engages with the feed rail.

19. The method according to claim 15, having the following further steps:
moving of the first cutting unit in the traverse direction completely through the main strip, so that the guide strip corresponds to the material web, and
fastening of the further longitudinal edge of the material web to the transport device of the second stretching unit; or
moving the two first cutting units in the traverse direction towards each other and then removing the cutting units from the material web.

20. The method according to claim 19, wherein the section of the pivotable conveyor, on which the main strip runs, is moved into the second position before or while the first cutting unit is moved, or
that the support is pivoted or adjusted in height so that a conveying path is provided from the receiving path to the transport device of the second stretching unit and/or the static conveyor before or while the first cutting unit is moved, or
that as soon as, before or after the first cutting unit is moved, the other one of the feed rails moves in the traverse direction towards the second conveyor until the further longitudinal edge of the material web engages with the feed rail.
